(19) United States
(12) Patent Application Publication
(10) Pub. No.: US 2024/0059192 A1
(43) Pub. Date: Feb. 22, 2024

(54) VEHICLE SEAT GROUNDING

(71) Applicant: Tactual Labs Co., New York, NY (US)

(72) Inventors: DANIEL IRONSIDE, Austin, TX (US); ADAM LANDA, Green Cove Springs, FL (US); GREG WIESE, Austin, TX (US); BRAON MOSELEY, Round Rock, TX (US)

(73) Assignee: Tactual Labs Co., New York, NY (US)

(21) Appl. No.: 18/271,723

(22) PCT Filed: Jan. 11, 2022
(86) PCT No.: PCT/US2022/011899

§ 371 Date: Jul. 11, 2023

Related U.S. Application Data
(60) Provisional application No. 63/136,114, filed on Jan. 11, 2021.

(51) Int. Cl. B60N 2/00; H01Q 1/22

(52) U.S. Cl. CPC B60N 2/0027; B60N 2/0029; B60N 2/0035; B60N 2/0033; H01Q 1/22

(57) ABSTRACT

A sensing system determines movement and position of passengers and objects within a vehicle. In particular, the determination of the position and movement of body parts can be enhanced by providing features that provide a source of ground for the system. The sensing system is able to transmit a plurality of signals during a transmission period and use the sensed signals during a frame in order to create different heat maps that represent movement and position of person during an integration period. By taking advantage of grounding sources, the system is able to better determine the position and movement of a person or object.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The disclosed systems and methods relate in general to the field of sensing, and in particular to enhancing sensing within a vehicle environment.

### BRIEF DESCRIPTION OF THE DRAWINGS

The foregoing and other objects, features, and advantages of the disclosure will be apparent from the following more particular description of embodiments as illustrated in the accompanying drawings in which reference characters refer to the same parts throughout the various views. The drawings are not necessarily to scale, emphasis instead being placed upon illustrating principles of the disclosed embodiments.

FIG. 1 is an illustration of occupants within a vehicle.

FIG. 2 shows a front view of an embodiment of a sensing system used with a vehicle seat.

FIG. 3 shows a back view of an embodiment of a sensing system used with a vehicle seat.

FIG. 4 shows a vehicle seat having a grounding portion.

FIG. 5 shows a diagram of a sectional view of the vehicle seat.

### DETAILED DESCRIPTION

In various embodiments, the present disclosure is directed to sensing systems sensitive to the determination of movement and position of passengers and objects within a vehicle. In particular, the determination of the position and movement of occupants and objects can be enhanced by providing grounding portions in the sensing system. The sensing system is able to transmit a plurality of signals during a transmission period and use the sensed signals during a frame in order to create different heat maps that represent movement and position of person during an integration period. By taking advantage of grounding portions, the system is able to better determine the position and movement of an occupant or object.

Throughout this disclosure, the term “event” may be used to describe periods of time in which movement and/or position of a body or object is determined. In accordance with an embodiment, events may be detected, processed, and/or supplied to downstream computational processes with very low latency, e.g., on the order of ten milliseconds or less, or on the order of less than one millisecond.

As used herein, and especially within the claims, ordinal terms such as first and second are not intended, in and of themselves, to imply sequence, time or uniqueness, but rather, are used to distinguish one claimed construct from another. In some uses where the context dictates, these terms may imply that the first and second are unique. For example, where an event occurs at a first time, and another event occurs at a second time, there is no intended implication that the first time occurs before the second time, after the second time or simultaneously with the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristics. Thus, for example, a first and a second frequency, absent further limitation, could be the same frequency, e.g., the first frequency being 10 Mhz and the second frequency being 10 Mhz; or could be different frequencies, e.g., the first frequency being 10 Mhz and the second frequency being 11 Mhz. Context may dictate otherwise, for example, where a first and a second frequency are further limited to being frequency-orthogonal to each other, in which case, they could not be the same frequency.

The present application contemplates various embodiments of sensing systems. The sensing systems described herein are suited for use with frequency-orthogonal signaling techniques (see, e.g., U.S. Pat. Nos. 9,019,224 and 9,529,476, and 9,811,214, all of which are hereby incorporated herein by reference). The sensing systems discussed herein may be used with other signal techniques, including scanning or time division techniques, and/or code division techniques. It is pertinent to note that the sensing systems described and illustrated herein are suitable for use in connection with signal infusion (also referred to as signal injection) techniques and apparatuses. Signal infusion is a technique in which a signal is transmitted to a person, that signal being capable of travelling on, within and through the person. In an embodiment, an infused signal causes the object of infusion (e.g., a hand, finger, arm or entire person) to become a transmitter of the signal.

The presently disclosed systems and methods further involve principles related to and for designing, manufacturing and using capacitive based sensors and capacitive based sensors that employ a multiplexing scheme based on orthogonal signaling such as but not limited to frequency-division multiplexing (FDM), code-division multiplexing (CDM), or a hybrid modulation technique that combines both FDM and CDM methods. References to frequency herein could also refer to other orthogonal signal bases. As such, this application incorporates by reference Applicant's prior U.S. Pat. No. 9,019,224, entitled “Low-Latency Touch Sensitive Device” and U.S. Pat. No. 9,158,411 entitled “Fast Multi-Touch Post Processing.” These applications contemplate FDM, CDM, or FDM/CDM hybrid touch sensors having concepts that are germane to and able to be used in connection with the presently disclosed sensors. In the aforementioned sensors, interactions are sensed when a signal from a row conductor is coupled (increased) or decoupled (decreased) to a column conductor and the result detected from that column conductor. By sequentially exciting the row conductors and measuring the coupling of the excitation signal at the column conductors, a heatmap reflecting capacitance changes of the sensor, and thus proximity to the sensor, can be created. The entire disclosure of these patents and applications incorporated therein by reference are incorporated herein by reference.

This application also employs principles used in fast multi-touch sensors and other interfaces disclosed in the following: U.S. Pat. Nos. 9,933,880; 9,019,224; 9,811,214; 9,804,721; 9,710,113; 9,158,411; 10,191,579; 10,386,975; 10,175,772; 10,528,201; 10,528,182; 10,795,437; and 11,099,680. Familiarity with the disclosure, concepts and nomenclature within these patents is presumed. The entire disclosure of these patents and applications incorporated therein by reference are incorporated herein by reference. This application also employs principles used in fast multi-touch sensors and other interfaces disclosed in the following: U.S. Pat. Nos. 10,191,579; 10,386,975; 10,175,772; 10,528,201; 10,620,696; 10,705,667; 10,928,180; U.S. Patent Application Publication No. US 2017/0371487 A1; U.S. Patent Provisional Nos. 62/540,458; 62/575,005; 62/621,117; 62/619,656; and PCT Publication No. WO 2020/264163 A1, familiarity with the disclosures, concepts and nomenclature therein is presumed. The entire disclosure of those applications and the applications incorporated therein by reference are incorporated herein by reference.

Certain principles of a fast multi-touch (FMT) sensor have been disclosed in the patent applications discussed above. Orthogonal signals may be transmitted into a plurality of transmitting antennas (or conductors) and information may be received by receivers attached to a plurality of receiving antennas (or conductors). In an embodiment, receivers “sample” the signal present on the receiving antennas (or conductors) during a sampling period (τ). In an embodiment, signal (e.g., the sampled signal) is then analyzed by a signal processor to identify touch events (including, e.g., actual touch, near touch, hover and farther away events that cause a change in coupling between a transmitting antenna (or conductor) and receiving antennas (or conductor)). In an embodiment, one or more transmitting antennas (or conductors) can move with respect to one or more receiving antennas (or conductors), and such movement causes a change of coupling between at least one of the transmitting antennas (or conductors) and at least one of the receiving antennas (or conductors). In an embodiment, one or more transmitting antennas (or conductors) are relatively fixed with respect to one or more receiving antennas (or conductors), and the interaction of the signal and/or signals transmitted with environmental factors causes a change of coupling between at least one of the transmitting antennas (or conductors) and at least one of the receiving antennas (or conductors). The transmitting antennas (or conductors) and receiving antennas (or conductors) may be organized in a variety of configurations, including, e.g., a matrix where the crossing points form nodes, and interactions are detected by processing of received signals. In an embodiment where the orthogonal signals are frequency orthogonal, spacing between the orthogonal frequencies, Δf, is at least the reciprocal of the measurement period τ, the measurement period τ being equal to the period during which the column conductors are sampled. Thus, in an embodiment, the received at a column conductor may be measured for one millisecond (τ) using frequency spacing (Δf) of one kilohertz (i.e., Δf=1/τ).

In an embodiment, the signal processor of a mixed signal integrated circuit (or a downstream component or software) is adapted to determine at least one value representing each frequency orthogonal signal transmitted to (or present on) a row conductor (or antenna). In an embodiment, the signal processor of the mixed signal integrated circuit (or a downstream component or software) performs a Fourier transform on the signals present on a receive antenna (or conductor). In an embodiment, the mixed signal integrated circuit is adapted to digitize received signals. In an embodiment, the mixed signal integrated circuit (or a downstream component or software) is adapted to digitize the signals present on the receive conductor or antenna and perform a discrete Fourier transform (DFT) on the digitized information. In an embodiment, the mixed signal integrated circuit (or a downstream component or software) is adapted to digitize the signals present on the received conductor or antenna and perform a Fast Fourier transform (FFT) on the digitized information—an FFT being one type of discrete Fourier transform.

It will be apparent to a person of skill in the art in view of this disclosure that a DFT, in essence, treats the sequence of digital samples (e.g., window) taken during a sampling period (e.g., integration period) as though it repeats. As a consequence, signals that are not center frequencies (i.e., not integer multiples of the reciprocal of the integration period (which reciprocal defines the minimum frequency spacing)), may have relatively nominal, but unintended consequence of contributing small values into other DFT bins. Thus, it will also be apparent to a person of skill in the art in view of this disclosure that the term orthogonal as used herein is not “violated” by such small contributions. In other words, as the term frequency orthogonal is used herein, two signals are considered frequency orthogonal if substantially all of the contribution of one signal to the DFT bins is made to different DFT bins than substantially all of the contribution of the other signal.

When sampling, in an embodiment, received signals are sampled at at least 1 MHz. In an embodiment, received signals are sampled at at least 2 MHz. In an embodiment, received signals are sampled at at least 4 Mhz. In an embodiment, received signals are sampled at 4.096 Mhz. In an embodiment, received signals are sampled at more than 4 MHz. To achieve kHz sampling, for example, 4096 samples may be taken at 4.096 MHz. In such an embodiment, the integration period is 1 millisecond, which per the constraint that the frequency spacing should be greater than or equal to the reciprocal of the integration period provides a minimum frequency spacing of 1 KHz. (It will be apparent to one of skill in the art in view of this disclosure that taking 4096 samples at e.g., 4 MHz would yield an integration period slightly longer than a millisecond, and not achieving kHz sampling, and a minimum frequency spacing of 976.5625 Hz.) In an embodiment, the frequency spacing is equal to the reciprocal of the integration period. In such an embodiment, the maximum frequency of a frequency-orthogonal signal range should be less than 2 MHz. In such an embodiment, the practical maximum frequency of a frequency-orthogonal signal range should be less than about 40% of the sampling rate, or about 1.6 MHz. In an embodiment, a DFT (which could be an FFT) is used to transform the digitized received signals into bins of information, each reflecting the frequency of a frequency-orthogonal signal transmitted which may have been transmitted by the transmitting antenna. In an embodiment 2048 bins correspond to frequencies from 1 KHz to about 2 MHz. It will be apparent to a person of skill in the art in view of this disclosure that these examples are simply that, exemplary. Depending on the needs of a system, and subject to the constraints described above, the sample rate may be increased or decreased, the integration period may be adjusted, the frequency range may be adjusted, etc.

In an embodiment, a DFT (which can be an FFT) output comprises a bin for each frequency-orthogonal signal that is transmitted. In an embodiment, each DFT (which can be an FFT) bin comprises an in-phase (I) and quadrature (Q) component. In an embodiment, the sum of the squares of the I and Q components is used as a measure corresponding to signal strength for that bin. In an embodiment, the square root of the sum of the squares of the I and Q components is used as measure corresponding to signal strength for that bin.

Further discussion regarding the implementation of the transmitting antennas (or conductors) and receiving antennas (or conductors) in association with vehicles can be found in U.S. Pat. No. 10,572,088 and U.S. patent application Ser. No. 16/799,691, the contents of all of the aforementioned applications incorporated herein by reference.

Transmitting antennas (also referred to as conductors) and receiving antennas (also referred to as conductors) can be implemented in the materials and fabrics used within or on components of the vehicle. One such implementation places the sensing systems within materials forming the car seat, such as fabrics, leather, etc. In an embodiment, sensing systems are located within seats made of cloth. In an embodiment, sensing systems are located on seats made of cloth. In an embodiment, sensing systems are located on seats made of leather. In an embodiment, sensing systems are located within seats made of leather. In an embodiment, sensing systems are located on seats made of leather. In an embodiment, sensing systems are located within seats made of plastic. In an embodiment, sensing systems are located on seats made of plastic. In an embodiment, sensing systems are located proximate to and or otherwise operably located near a passenger's location.

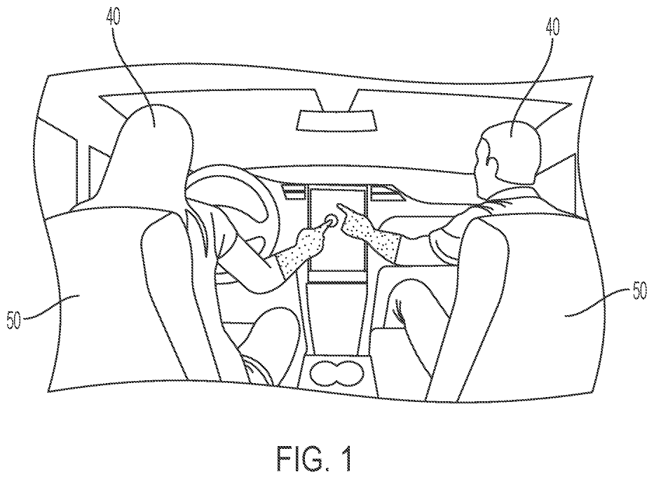

Referring to FIG. 1, shown are occupants 40 sitting on seats 50 located within a vehicle. While the seats 50 shown in FIG. 1 are the seats located in the front row, it should be understood that any of the seats located within the vehicle may have sensing systems implemented therein, on, or proximate to an occupant. Additionally, sensing systems may be located in a portion of a vehicle seat or in more than one portion of a vehicle seat or vehicle seats. Furthermore, sensing systems may be located throughout the vehicle and in certain situations the sensing systems may be located at a location other than or in addition to a vehicle seat that permits determination of activity within the vehicle or the presence of a passenger.

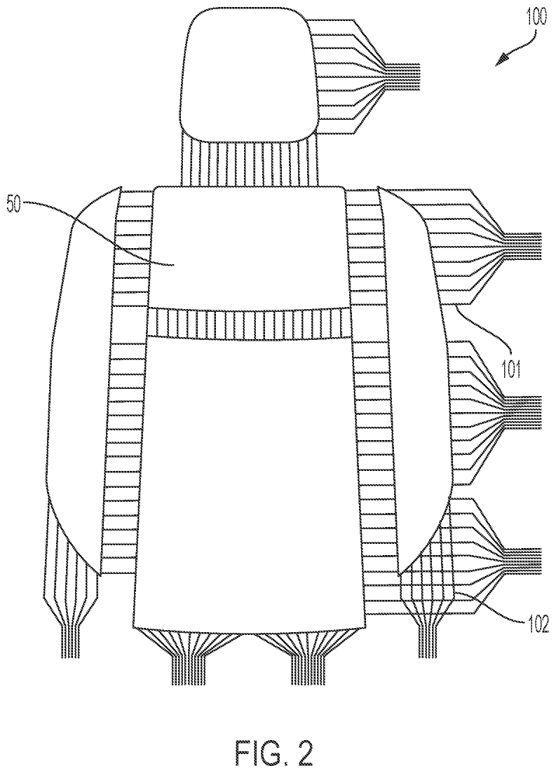

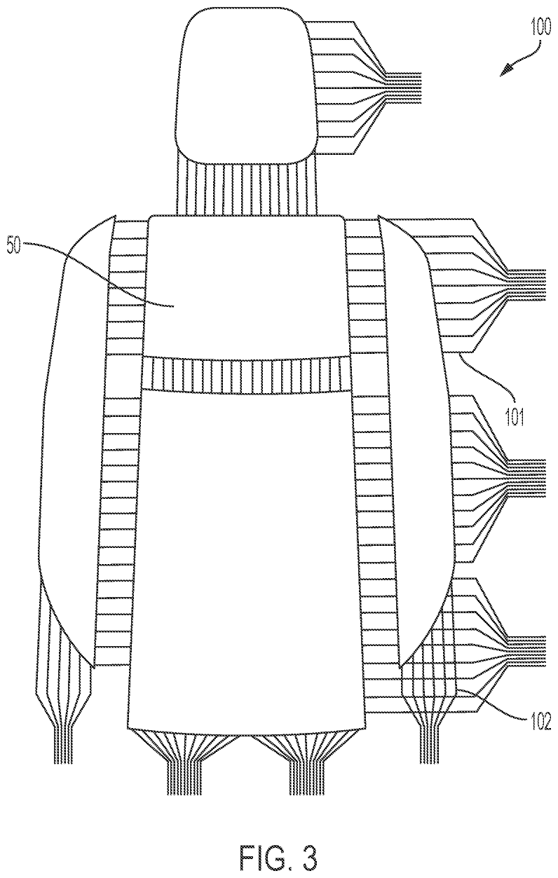

FIG. 2 shows a front view of a top layer of the seat 50. FIG. 3 shows a rear view of the top layer of the seat 50. The sensing system 100 is formed with transmitting antennas 101 and receiving antennas 102, which are operably connected to at least one transmitter (not shown), at least one receiver (not shown), and at least one signal processor (not shown). In an embodiment, transmitting antennas 101 can also function as receiving antennas and receiving antennas 102 can also function as transmitting antennas. In an embodiment, there is more than one layer of the sensing system 100 used in the seat 50. In an embodiment, each portion of the seat 50 has its own sensing system. In an embodiment, only some portions of the seat 50 have sensing systems. In an embodiment, the sensing systems are formed throughout an entirety of the seat 50. In FIGS. 2 and 3, the sensing system 100 is formed within the substantial portion of the seat 50.

In an embodiment, each transmitting antenna 101 transmits a unique orthogonal signal. In an embodiment, each transmitting antenna 101 transmits a unique frequency orthogonal signal. Receiving antennas 102 are adapted to receive signals transmitted by the transmitting antennas 101. Signals received by the receiving antennas 102 during a period of time (aka as integration period of time) are used to determine information regarding the item or person located on or proximate to the seat 50. In an embodiment, the information is determined via the formation of heat maps based on the signals received by the receiving antennas 102 and subsequently processed.

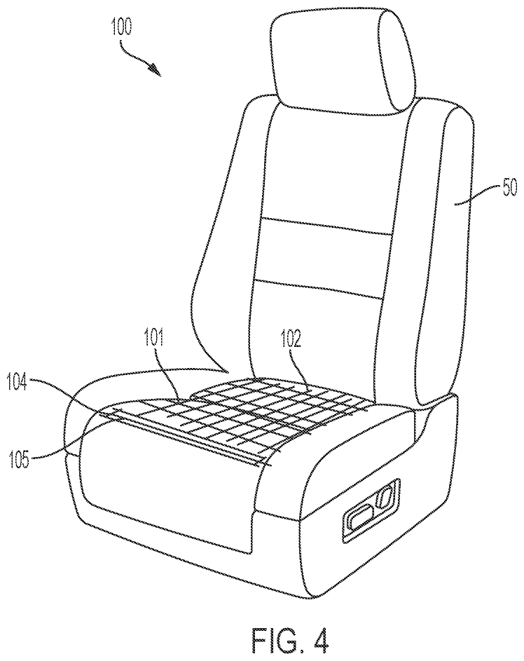

FIG. 4 shows a seat 50 incorporating a sensing system 100 having transmitting antennas 101 and receiving antennas 102. The sensing system 100 shown in FIG. 4 also implements a dielectric portion 104 and grounding portion 105 proximate to the transmitting antennas 101 and the receiving antennas 102.

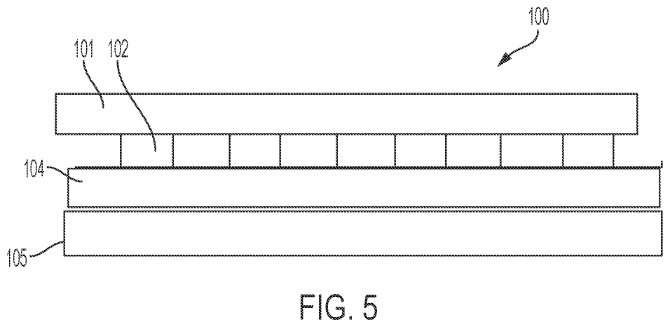

FIG. 5 shows a sectional view of the sensing system 100 with transmitting antenna 101 and receiving antennas 102. Further, shown in FIG. 5, located proximate to the transmitting antenna 101 and the receiving antennas 102, is dielectric portion 104 and grounding portion 105.

The grounding portion 105 is operably connected to a source of ground. In an embodiment the source of ground is ultimately a portion of the vehicle in which the sensing system 100 is located, such as the vehicle chassis. In an embodiment, the grounding portion 105 is formed as a plane that substantially conforms to the layout of the transmitting antennas 101 and the receiving antennas 102. In an embodiment, the grounding portion 105 is formed to conform to the layout of the transmitting antennas 101 and the receiving antennas 102. In an embodiment, the grounding portion 105 is formed to conform to the shape and orientation of that portion of the sensing system 100 that is movable. In an embodiment, the grounding portion 105 is one of a plurality of grounding portions that are located within the vehicle. In an embodiment, the grounding portion 105 is operably connected to more than one grounding source.

The dielectric portion 104 shown in FIGS. 4 and 5 is located between the grounding portion 105 and the antennas. In an embodiment, the dielectric portion 104 is formed from a compressible foam material. However, it should be understood that the dielectric portion 104 may be formed from any material that is suitably nonconductive and compressible. In an embodiment, the function of the dielectric portion is fulfilled by air, which is to say there is no other solid physical dielectric. In an embodiment, the dielectric portion 104 is made from more than one type of material. In an embodiment, the dielectric portion 104 is formed from more than one type of material and air.

In operation, an occupant of the vehicle sits in the seat 50. A portion of seat 50 has a sensing system 100 that is adapted to move in response to the weight of the occupant and/or an object. The occupant capacitively impacts the signals that are transmitted and received by the antennas. By providing a source of ground proximate to transmitting antennas 101 and receiving antennas 102, the signals that are received by the receiving antennas 102 are able to be better discriminated when processed. For example, due to compression of the seat towards the grounding portion 105, the signals measured at those portions of the seat 50 closer to the grounding portion 105 are better able to be determined than if there was not any grounding portion 105.

In addition to being able to better discriminate the received signals caused by compression of the seat 50 at those locations closer to the grounding portion 105, it is further possible to use relative position with respect to the grounding portion 105 in order to better discriminate the impact of various other structures in the vehicle on the measured signals. For example, components, such as seat belt restraints, etc. may have an impact on the signals that are received and the usage of the grounding portion 105 helps to determine what the impact of that vehicle component is on the overall sensing system 100. In an embodiment, the grounding portion 105 shields the sensing system from other sources that may impact the measurement of signals.

In an embodiment, the grounding portion 105 is adapted to be switched between an active and inactive state. Measurements taken during each of the two states can be used to determine the impact of various components within the vehicle on the system by comparing measurements taken during an integration period when the grounding portion 105 is activated and the measurements taken during an integration period when the grounding portion is not activated.

In an embodiment, the material of a seat has embedded within it a sensing system formed of transmitting and receiving antennas (also referred to herein as conductors). In an embodiment, the material of the seat has placed on it a sensing system formed of transmitting and receiving antennas. In an embodiment, the seat has embedded within it and placed upon it sensing systems formed of transmitting and receiving antennas. In an embodiment, antennas are placed upon a flexible substrate (which could be made from a non-conductive fabric, plastic or elastomeric material) and used to form the material of the seat. In an embodiment, antennas are embedded within a flexible substrate and used to form the material of the seat. In an embodiment, a conductive thread is placed on or stitched into a flexible material (e.g., fabric) in a manner that permits a desired expansion (e.g., zig-zag, waves, etc.) in one or more desired dimensions and used to form the seat. In an embodiment, a flexible substrate or fabric has crossing zig-zag patterns (or e.g., crossing sine wave patterns) used to form the seat. In an embodiment, the flexible substrate or the fabric has one of the patterns discussed above or another pattern adapted to withstand the flexible use by people.

A transmitter transmits a unique frequency orthogonal signal on each of the transmitting antennas. Receiving antennas can receive the transmitted signals and/or respond to the capacitive interaction that can occur through usage of the material. A signal processor processes a measurement of the received signals and uses the measurements in order to form a heat map, or other set of data, reflecting the interaction that is occurring with the car seat. In an embodiment, each of the transmitting antennas and each of the receiving antennas functions as either a transmitting antenna or receiving antenna. In an embodiment, there is at least one transmitting antenna and a plurality of receiving antennas. In an embodiment, there is a plurality of transmitting antennas and at least one receiving antenna.

When an occupant 40 sits on the seat 50 in the car there is movement of and/or within the seat 50. The material from which the seat 50 is formed moves and/or flexes. In an embodiment, this movement causes the transmitting antennas and receiving antennas to move. In an embodiment, the movement causes the transmitting antennas and receiving antennas to move with respect to each other. This movement impacts the measurement of signal that is received by the receiving antennas. This movement not only occurs when an occupant 40 sits on the seat 50, but also during the movement of the vehicle and while the occupant 40 is sitting on the seat 50 when the car is at rest. Additionally, the occupant 40 can interact with the field generated by the transmitting antenna or antennas and the receiving antenna or antennas. The interaction of the occupant with the field causes different measurements to be taken by the system

Processed measurements taken from the receivers connected to the receiving antennas can be used in order to determine whether or not an occupant 40 is seated on the seat 50. The measurements taken and processed by the signal processor are able to be used by the sensing system to be further processed in order to determine a use of the seat 50. In an embodiment, a determination of the use of the seat is run on the signal processor and is able to take the measurements and determine if there is a use of the seat. In an embodiment, the determination of the use of the seat is performed by software logic that processes the measurements processed by the signal processor. In an embodiment, the determination of the use of the seat is determined by a part of the sensing system located separately from the signal processor. In an embodiment, the determination of the use of the seat is performed by circuitry that processes the measurements processed by the signal processor. In an embodiment, the determination of the use of the seat is performed by part of the sensing system located in the vehicle at a location away from the seat. In an embodiment, the determination of the use of the seat is located in the vehicle at a location proximate to the seat.

In an embodiment, the sensing system detects a presence or absence of an occupant of the vehicle. In an embodiment, the sensing system detects a biometric of an occupant. In an embodiment, the sensing system determines the heart rate of an occupant. In an embodiment, the sensing system determines respiratory activity of an occupant. In an embodiment, the sensing system determines a weight estimate of an occupant. In an embodiment, the sensing system determines a height estimate of an occupant. In an embodiment, the sensing system detects the position of an occupant within the seat. In an embodiment, the sensing system detects a type of occupant within the seat. In an embodiment, the sensing system determines if a car is stolen or being properly utilized based on determined occupant ID. In an embodiment, the sensing system detects the presence of a child. In an embodiment, the sensing system detects the presence of a child seat. In an embodiment, the sensing system detects the presence of a child in the child seat. In an embodiment, the sensing system detects the position of the occupant within the vehicle. In an embodiment, the sensing system determines the position of a seat back. In an embodiment, the sensing system determines the comfort settings of a seat. In an embodiment, the sensing system detects the distance of a head from head rest. In an embodiment, the sensing system detects a type of % classification category of occupant vs. non-occupant detection (i.e. an object present but exclusively not a human occupant). In an embodiment, the sensing system determines if something is left behind in a vehicle. In an embodiment, the sensing system detects an object. In an embodiment, the sensing system detects an object via passive means. In an embodiment, the sensing system detects an object via active means. In an embodiment, the sensing system detects a type of occupant object by either active and/or passive means. In an embodiment, the sensing system detects at least one of a person, car seat, purse, laptop, phone, dog, cat, etc. In an embodiment, each logic category (i.e., presence or absence of human occupant), or measurement estimation (i.e. height weight) can each separately also include a calculated factor of confidence (i.e. confidence level) (e.g. 99.9999% empty, 80% confidence height 5′6″). In an embodiment, the sensing system detects cushion and back pressure distribution. In an embodiment, the sensing system determines dynamic movement, such as how much and how often an occupant moves.

As noted above, information in addition to presence regarding the occupant 40 can be ascertained due to the sensitivity of the sensors being implemented. In an embodiment, machine learning is applied to the data received from the measurements taken by the sensing system within or on seat 50 in order to accurately determine the weight of the individual sitting on seat 50. By being able to accurately determine physical characteristics of the person sitting on the seat 50, the vehicle can further be programmed to respond accordingly by correlating the weight of the person with the likely identity of the driver. For example, in an embodiment, the vehicle automatically adjusts its settings when the sensing system 100 senses that a 185 pound man is sitting in the car. The settings of the car may be adjusted for the person most likely associated with the 185 pound weight reading. In an embodiment, the number of occupants in a vehicle is determined using the measurements from the sensing system 100. In an embodiment, the number of and weight of the occupants in a vehicle is determined using the sensors. In an embodiment, the vehicle is programmed in order to determine the identity of the occupants 40 based upon where they are sitting, their weight and/or other physical characteristics ascertained via the sensing system 100. In an embodiment, the vehicle optimizes fuel usage based on the vehicle load determined by the sensing system 100. In an embodiment, sensing systems in the passenger area determine, based on the weight reading, if there remains an infant in a car seat. This reading is then used to trigger an alarm, or other warning indicator, if the infant is not removed when the vehicle is stopped for a period of time.

It should be understood that sensing systems 100 may be located at other locations on and within the seat 50 in addition to the sitting area of the seat 50. In an embodiment, sensing systems 100 are located within the back area of the seat 50. sensing systems 100 located in the back area of the seat 50 can be used in order to determine information regarding various movements of the occupant. For example, sudden movements can be used in order to determine additional information related to the speed of the vehicle or the terrain the vehicle may be moving over. In an embodiment, this type of information is used by the vehicle to adjust the controls of the vehicle or the movement of the vehicle. For example, in an embodiment, determination that there is sudden movement or jerking over a threshold deploys airbags or triggers brake activity. In an embodiment, sensing systems are located within the headrest of the vehicle. In an embodiment, biometric data is taken regarding the occupant 40 based upon his or her interaction with the seat 50. In an embodiment, the position and movements of an occupant 40 are used to determine if the occupant 40 is falling asleep. An alarm can be triggered if the occupant is falling asleep. Other potentially dangerous situations can also be monitored and detected by the sensing systems based on positioning and movements of the occupant 40 while on the seat 50, such as distracted driving and driving under the influence of a substance.

Furthermore, while car seats are shown, it should be understood that the sensing systems can be used with the seats of vehicles other than cars. In an embodiment, the sensing systems are used in truck seats. In an embodiment, the sensing systems are used in boat seats. In an embodiment, the sensing systems are embedded in waterproof material in the boat seats. In an embodiment, the sensing systems are used in plane seats. In an embodiment, the sensing systems are used in train seats.

Also, while the seats discussed herein are discussed within the context of vehicles, seats, chairs and the like, the sensing systems can be implemented within or on fabrics and materials within seats found elsewhere. In an embodiment, the sensing systems are used in stadium seats. In an embodiment, the sensing systems are used with chairs within homes. In an embodiment, the sensing systems are used with seating in waiting rooms. In an embodiment, the sensing systems are used with seating on rides in amusement parks.

An aspect of the disclosure is a sensing system. The sensing system comprising a group of transmitting antennas operably connected to a vehicle seat, each transmitting antenna adapted to transmit a signal that is orthogonal to each other signal transmitted during an integration period, a plurality of receiving antennas, each one of the plurality of receiving antennas adapted to receive transmitted signals; a processor adapted to determine a measurement of transmitted signals received, wherein the processor is further adapted to process the measurements to determine position or movement of an occupant of the vehicle seat; and a grounding portion located proximate to at least one of the plurality of receiving antennas or at least one of the plurality of transmitting antennas, the grounding portion adapted to enhance determination of the measurements of the transmitted signals received.

Another aspect of the disclosure is a sensing system. The sensing system comprising at least one transmitting antenna adapted to transmit a signal that is orthogonal to each other signal transmitted during an integration period, at least one receiving antenna adapted to receive transmitted signals; a processor adapted to determine a measurement of transmitted signals received, wherein the processor is further adapted to process the measurements to determine position or movement of a person; and a grounding portion located proximate to the at least one receiving antenna or the at least one transmitting antenna, the grounding portion adapted to enhance determination of the measurements of transmitted signals received.

Still yet another aspect of the disclosure is a sensing system. The sensing system comprising at least one transmitting antenna adapted to transmit a signal that is orthogonal to each other signal transmitted during an integration period, at least one receiving antenna adapted to receive transmitted signals; a processor adapted to determine a measurement of transmitted signals received, wherein the processor is further adapted to process the measurements to determine position or movement; and a grounding portion adapted to enhance determination of the measurements of transmitted signals received during approach of the at least one transmitting antenna or the at least one receiving antenna.

While the invention has been particularly shown and described with reference to a preferred embodiment thereof, it will be understood by those skilled in the art that various changes in form and details may be made therein without departing from the spirit and scope of the invention.

1. A sensing system, comprising:
a group of transmitting antennas operably connected to a vehicle seat, each transmitting antenna adapted to transmit a signal that is orthogonal to each other signal transmitted during an integration period,
a plurality of receiving antennas, each one of the plurality of receiving antennas adapted to receive transmitted signals;
a processor adapted to determine a measurement of transmitted signals received, wherein the processor is further adapted to process the measurements to determine position or movement of an occupant of the vehicle seat; and
a grounding portion located proximate to at least one of the plurality of receiving antennas or at least one of the plurality of transmitting antennas, the grounding portion adapted to enhance determination of the measurements of the transmitted signals received.

2. The sensing system of claim 1, further comprising a dielectric portion operably located between the grounding portion and at least one of the plurality of transmitting antennas or at least one of the plurality of receiving antennas.

3. The sensing system of claim 1, wherein the dielectric portion is made of a foam material.

4. The sensing system of claim 1, wherein the grounding portion is formed as a ground plane.

5. The sensing system of claim 1, wherein the grounding portion is operably connected to a portion of a vehicle.

6. The sensing system of claim 1, wherein compression of the vehicle seat is determined, in part, by movement of at least one of the plurality of transmitting antennas or at least one of the plurality of receiving antennas with respect to the grounding portion.

7. The sensing system of claim 1, wherein the grounding portion is adapted to be switched between being connected to a source of ground and not being connected to the source of ground.

8. A sensing system, comprising:
at least one transmitting antenna adapted to transmit a signal that is orthogonal to each other signal transmitted during an integration period,
at least one receiving antenna adapted to receive transmitted signals;
a processor adapted to determine a measurement of transmitted signals received, wherein the processor is further adapted to process the measurements to determine position or movement of a person; and
a grounding portion located proximate to the at least one receiving antenna or the at least one transmitting antenna, the grounding portion adapted to enhance determination of the measurements of transmitted signals received.

9. The sensing system of claim 1, further comprising a dielectric portion operably located between the grounding portion and the at least one transmitting antenna or the at least one receiving antenna.

10. The sensing system of claim 1, wherein the dielectric portion is made of a foam material.

11. The sensing system of claim 1, wherein the grounding portion is formed as a ground plane.

12. The sensing system of claim 1, wherein the grounding portion is operably connected to a portion of a vehicle.

13. The sensing system of claim 1, wherein compression of a vehicle seat is determined, in part, by movement of at least one transmitting antenna or the at least one receiving antenna with respect to the grounding portion.

14. The sensing system of claim 1, wherein the grounding portion is adapted to be switched between being connected to a source of ground and not being connected to the source of ground.

15. A sensing system, comprising:
at least one transmitting antenna adapted to transmit a signal that is orthogonal to each other signal transmitted during an integration period,
at least one receiving antenna adapted to receive transmitted signals;
a processor adapted to determine a measurement of transmitted signals received, wherein the processor is further adapted to process the measurements to determine position or movement; and
a grounding portion adapted to enhance determination of the measurements of transmitted signals received during approach of the at least one transmitting antenna or the at least one receiving antenna.

16. The sensing system of claim 1, further comprising a dielectric portion operably located between the grounding portion and the at least one transmitting antenna or the at least one receiving antenna.

17. The sensing system of claim 1, wherein the dielectric portion is made of a foam material.

18. The sensing system of claim 1, wherein the grounding portion is operably connected to a portion of a vehicle.

19. The sensing system of claim 1, wherein compression of the car seat is determined, in part, by movement of the at least one transmitting antenna or the at least one receiving antenna with respect to the grounding portion.

20. The sensing system of claim 1, wherein the grounding portion is adapted to be switched between being connected to a source of ground and not being connected to the source of ground.
